(19) United States
(12) Patent Application Publication
(10) Pub. No.: US 2003/0083894 A1
(43) Pub. Date: May 1, 2003

(54) Wireless mailroom having a gateway server to allow remote access

(75) Inventors: Easton F. Bell, Norwalk, CT (US); Jean-Hiram Coffy, Norwalk, CT (US); Kenneth G. Miller, Bethel, CT (US); James R. Norris JR., Danbury, CT (US); Cheryl Picoult Triska, Monroe, CT (US)

Correspondence Address: Brian A. Lemm, Pitney Bowes Inc., 35 Waterview Drive, P.O. Box 3000, Shelton, CT, 06484, US

(73) Assignee: Pitney Bowes Incorporated, Stamford, CT

(21) Appl. No.: 10/021,583

(22) Filed: Oct. 29, 2001

(51) Int. Cl. G06F 17/60

(52) U.S. Cl. 705/1; 705/401

(57) ABSTRACT

A wireless mailing system that has a minimal number of interface cables between devices, while still maintaining full functionality, is easy to add devices to, and provides remote access for each device without having a dedicated telephone line for each device or having to transport each device to a telephone line is provided. A mailing system includes a plurality of devices, each of which is adapted to communicate with the other devices via a wireless communication link to form a local network. A gateway server can act as the master of the local network to coordinate communication between the devices in the local network, or alternatively, the devices in the local network can communicate directly with each other. Additionally, the gateway server allows remote access to the local network via a standard telephone network or other data network, such as, for example, the Internet.

### FIELD OF THE INVENTION

The invention disclosed herein relates generally to mailing systems, and more particularly to a wireless mailroom system and method for remotely accessing components of the wireless mailroom.

### BACKGROUND OF THE INVENTION

In many typical office mailroom environments, a wide variety of devices are utilized for efficient operation of the office, including, for example, postage meters, weighing scales, mail processing machines, i.e., inserters, sorters and the like, and personal computers. Many of these devices are typically coupled to each other to form a network and operate in conjunction with each other by passing information and data to each other via the network. Additionally, many of the above devices also need to conduct communications with a data center from time to time. For example, in many commercial applications, it is necessary to be able to remotely diagnose, update, refill and retrieve information from such devices. Such communications may be performed, for example, via a standard telephone line or a network such as the Internet.

There are problems, however, with conventional office mailroom environments. As more equipment is added to the mailroom, the corresponding interface cables and wires necessary to couple each new piece of equipment to the existing mailroom equipment and other new equipment also increases. The large number of interface cables can create problems with the routing of the cables, and accordingly affect the physical layout of the devices in the mailroom. For example, it may be necessary for several devices to be coupled together. With interface cables, these devices may have to in close physical proximity to each other. However, a layout of the devices made within the constraints of cable routing may not be the best suited for efficiency in operation of the overall mailroom system. Thus, the functionality of the mailroom may be negatively impacted. Additionally, when new devices are coupled to existing devices, the user may have to disconnect all interface cables and reconnect them in a different configuration to ensure proper operation of all devices in the mailroom network.

Another problem is that it may be necessary to provide each device with a dedicated telephone line to perform remote access. Providing a dedicated telephone line for each device will significantly increase costs, as it is then necessary to obtain and pay for multiple telephone lines, one for each piece of equipment. Alternatively, each device could be physically brought to a telephone line when remote access is necessary. This, however, is extremely cumbersome as it requires removal of all interface cables, transporting the device to the telephone line, and then reconnection of the device upon completion of the remote access.

Thus, there exists a need for a mailroom system that has a minimal number of interface cables between devices, but still maintains full functionality, is easy to add devices to, and provides remote access for each device without having a dedicated network connection, such as, for example, a telephone line, for each device or having to transport each device to a telephone line.

### SUMMARY OF THE INVENTION

The present invention alleviates the problems associated with the prior art and provides a mailing system that has a minimal number of interface cables between devices, but still maintains full functionality, is easy to add devices to, and provides remote access for each device without having a dedicated network connection for each device or having to transport each device to a network connection.

In accordance with the present invention, a mailing system includes a plurality of devices, each of which is adapted to communicate with the other devices via a wireless communication link to form a local network. A gateway server can act as the master of the local network to coordinate communication between the devices in the local network, or alternatively, the devices in the local network can communicate directly with each other. Additionally, the gateway server allows remote access to the local network via a standard telephone network or other data network, such as, for example, the Internet. Accordingly, only the gateway server needs to be provided with a dedicated telephone line or network connection. The use of wireless communications between each of the devices in the mailing system according to the present invention allows devices to be easily added to the system, as each new device being added will register with the gateway server upon automatically establishing a communication with the gateway server.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a wireless mailing system according to the present invention;

FIG. 2 illustrates in flow chart form a process performed by a gateway server relating to device registration according to the present invention; and

FIG. 3 illustrates in flow chart form a process of accessing the wireless system from a remote device according to the present invention.

### DETAILED DESCRIPTION OF THE PRESENT INVENTION

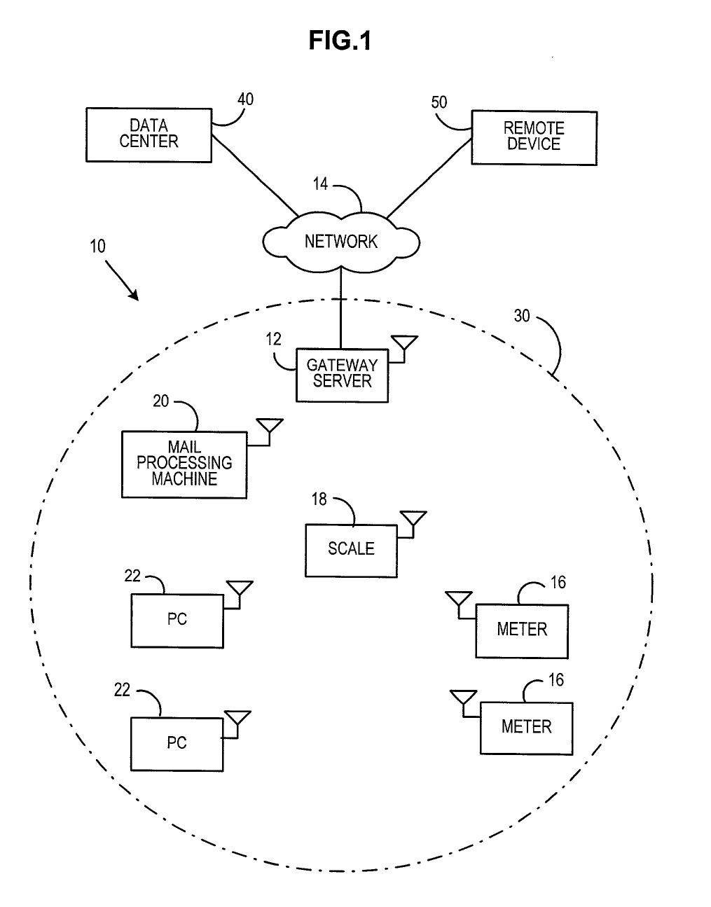

In describing the present invention, reference is made to the drawings, wherein there is seen in FIG. 1 a wireless mailing system 10 according to the present invention. System 10 includes a gateway server 12 that is coupled to a network 14, such as, for example, a Public Switched Telephone Network (PSTN). Alternatively, the network 14 may be, for example, the Internet. It should be understood that gateway server 12 could be coupled to more than one type of network simultaneously, such as, for example, both a PSTN and the Internet. System 10 also includes a plurality of devices typically used for preparing mail, such as, for example, one or more postage meters 16, a scale 18, a mail processing machine 20, i.e., a sorter, inserter, and the like, and one or more personal computers (PC) 22 or personal data assistants (PDA) (not shown). Computers 22 may be used, for example, to schedule, control and monitor the operation of the other devices, i.e., meter 16, scale 18 and mail processing machine 20. It should be understood that the system 10 is not limited to the number and type of devices as illustrated in FIG. 1, but instead can include any number of each of the devices and any type of device desired to be used in the mailing system 10.

Each of the gateway server 12, meter 16, scale 18, mail processing machine 20 and personal computer 22 is provided with a transmitter/receiver (not shown) to allow wireless communication, such as, for example, radio frequency communications, with other similarly equipped devices. Such wireless communications preferably utilize ad-hoc, spontaneous networking technology such as, for example, Bluetooth™ or IEEE 802.11. Accordingly, the system 10, including gateway server 12, meter 16, scale 18, mail processing machine 20, and personal computer 22, forms a local network 30, indicated by dashed line in FIG. 1. Gateway server 12 preferably operates as a master of the local network 30, coordinating communication between each of the devices in local network 30 and registering new devices in local network 30 as they are added as will be further described below. Alternatively, each of the devices in local network 30 can communicate directly with each other without coordination from the gateway server 12. Local network 30 preferably includes up to eight devices, including the master, actively participating in information exchange using a proprietary protocol, and can preferably include up to 256 devices registered but not actively participating in exchanging data if Bluetooth™ networking technology is utilized.

The gateway server 12, when acting as master of the local network 30, enables each of the devices included in local network 30 to communicate with each other wirelessly via gateway server 12. Thus, for example, a meter 16 and scale 18 can communicate with each other through gateway server 12 to exchange information and data. As noted above, information and data exchange is preferably done using a proprietary protocol to protect the integrity of the data included in the communications between the devices of local network 30. The use of wireless communication between devices of mailing system 10 of the present invention has several advantages over conventional mailing systems. For example, the use of wireless communications eliminates the need for interface cables between each of the devices, thereby allowing any physical layout of the devices desired, as long as the devices are within range of gateway server 12. When it is desired to add a new device to mailing system 10, the gateway server 12 will automatically establish a communication with the new device when it is within range of gateway server 12 and the new device will become part of the local network 30.

Replacement of devices is also facilitated by system 10 according to the present invention. For example, suppose a meter 16 is to be replaced by a new meter 16. The new meter 16, upon establishing a communication with gateway server 12, can exchange information with the old meter 16 via gateway server 12, such as, for example, registration numbers, authorization codes, encryption keys, etc., thereby ensuring a seamless replacement of the old meter 16. The coordination of the communications between devices in local network 30 by gateway server 12 allows new devices to be added without any of the existing devices having prior knowledge of the new devices and vice-versa. Additionally, the ability of each device in system 10 to communicate wirelessly greatly simplifies routine inspection and maintenance of the devices. For example, a service representative can now easily query each device, via a wireless communication, and receive status and diagnostic information without requiring any special type of interface connection.

As noted above, many devices in a typical mailing system need to conduct communications with a data center from time to time to update, refill and retrieve information. The system 10 according to the present invention simplifies such communications and also reduces the cost and labor involved. As shown in FIG. 1, gateway server 12 is coupled to a network 14, which may be, for example, a PSTN or the Internet. A data center 40 is also coupled to network 14, and can communicate with gateway server 12 via the network 14. Suppose, for example, a meter 16 needs to have postage funds refilled. The meter 16 will communicate with the gateway server 12, via a wireless communication. Gateway server 12 will then communicate with data center 40, via network 14, to request the refill. Data center 40 will provide the refill data to gateway server 12, which will then provide the refill data to meter 16 via a wireless communication. Similarly, suppose for example a rate change needs to be downloaded to a scale 18. The rate change will be sent from data center 40 to gateway server 12 via network 14, and then communicated from gateway server 12 to scale 18 via a wireless communication. Since all communications with the data center 40 are performed via gateway server 12, only gateway server 12 needs to have a telephone line or network connection, thus significantly reducing the number of telephone and/or network lines necessary. Additionally, in system 10 according to the present invention in which wireless communications are made between the devices in local network 30 and gateway server 12, it is not necessary to physically transport any of the devices included in local network 30 to the telephone line or network connection to communicate with the data center 40, thereby further simplifying the operation of system 10 over conventional mailroom systems.

System 10 according to the present invention also allows remote access to any of the devices in local network 30 via network 14. For example, a remote device 50 can access the gateway server 12 via network 14 to invoke a service of system 10 from any of the devices included in local network 30. Thus, a remote device, such as, for example, a personal computer or PDA, could be used to access a device in local network 30, such as, for example, a meter 16, and remotely perform a service associated with meter 16, such as, for example, refilling of postage funds. Additionally, a remote device 50 can gain access to a device in local network 30 to obtain operating status information of a device in local network 30.

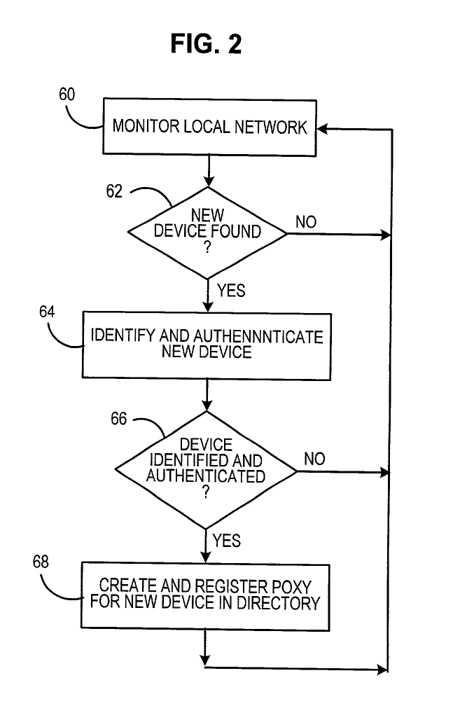

To allow remote access by a remote device 50, gateway server 12 maintains and continuously updates a directory of devices included in local network 30 for selection by remote device 50. FIG. 2 illustrates in flow chart form a process performed by gateway server 12 relating to device registration in local network 30. In step 60, gateway server 12 continuously monitors local network 30 for any new devices that enter the local network 30. As noted above, the wireless communications of system 10 preferably utilize ad-hoc, spontaneous networking technology, and therefore any new device that comes into range of gateway server 12 will automatically communicate with gateway server 12 and thus gateway server 12 will attempt to enter the new device into the local network 30.

In step 62 it is determined if a new device is found within range of gateway server 12. If no new device is found, the gateway server continues to monitor the local network 30 in step 60. If a new device is found in step 62, then in step 64 the gateway server 12 attempts to identify and authenticate the new device. Such identification and authentication can be performed, for example, by comparison to device identification numbers stored in a database of gateway server 12. In step 66 it is determined if the new device has been identified and authenticated. If in step 66 it is determined the new device has not been either identified or authenticated, then the gateway server 12 returns to monitoring the local network 30 in step 60. If in step 66 it is determined the new device has been identified and authenticated, then in step 68 the gateway server 12 creates and registers a proxy for the device in a directory stored in gateway server 12. Gateway server 12 then returns to monitoring the local network 30 in step 60.

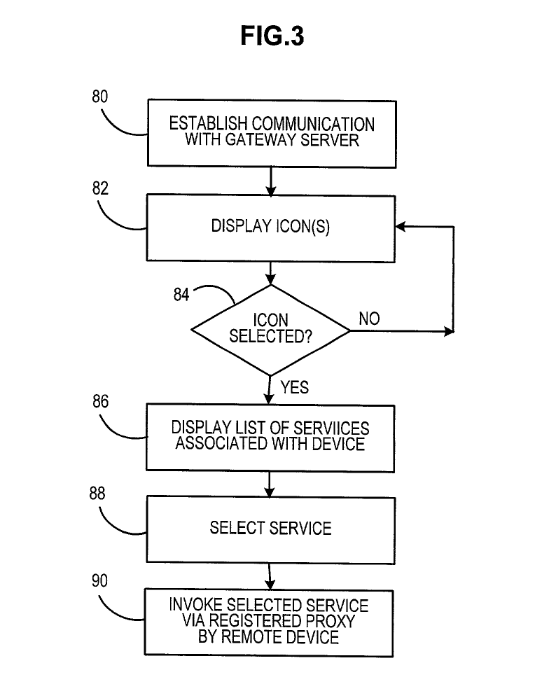

FIG. 3 illustrates in flow chart form the process of accessing the system 10 from a remote device 50. In step 80, remote device 50 establishes a communication with gateway server 12 via network 14. In step 82, one or more icons representing the proxies stored in gateway server 12 are displayed on a graphical user interface (GUI) (not shown) on remote device 50. In step 84 it is determined if a displayed icon has been selected. If an icon has not been selected, then the icons remain displayed on the GUI of remote device 50. If an icon has been selected in step 84, then in step 86 a list of available services associated with the device whose icon was selected is displayed. In step 88, the user can select a service from the list of available services, and in step 90 the remote device 50, via the registered proxy in gateway server 12, will invoke the selected service of the associated device in local network 30 via network 14, gateway server 12 and a wireless communication with the associated device of system 10.

Thus, according to the present invention, a mailing system is provided that has a minimal number of interface cables between devices, while still maintaining full functionality, is easy to add devices to, and provides remote access for each device without having a dedicated telephone line for each device or having to transport each device to a telephone line.

It should be understood that although the present invention was described with respect to the components of a mailroom system, the present invention is not so limited and is applicable to any type of wireless multi-component system wherein remote access is desired. While a preferred embodiment of the invention has been described and illustrated above, it should be understood that this is exemplary of the invention and is not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

what is claimed is:

1. A mailing system comprising:
a plurality of devices associated with mail preparation, each of said plurality of devices adapted to communicate with other devices via a wireless communication; and
a gateway server adapted to communicate with each of said plurality of devices via a wireless communication, said gateway server and said plurality of devices forming a local network, said gateway server acting as a master of said local network,
wherein each of said plurality of devices communicates with another of said plurality of devices via a wireless communication through said gateway server.

2. The system according to claim 1, wherein said wireless communications are radio frequency communications.

3. The system according to claim 2, wherein said radio frequency communications are automatically established.

4. The system according to claim 1, wherein said plurality of devices includes a scale.

5. The system according to claim 1, wherein said plurality of devices includes a postage meter.

6. The system according to claim 1, wherein said plurality of devices includes a mail processing machine.

7. The system according to claim 1, wherein said plurality of devices includes a personal computer.

8. The system according to claim 1, further comprising:
a data center coupled to a network,
wherein said gateway server is coupled to said network, said gateway server communicating with said data center via said network, said data center receiving data from and sending data to at least one of said plurality of devices via said network, said gateway server, and a wireless communication between said gateway server and said at least one of said plurality of devices.

9. The system according to claim 8, wherein said network is a public switched telephone network.

10. The system according to claim 8, wherein said network is the Internet.

11. The system according to claim 1, further comprising:
a remote device coupled to a network,
wherein said gateway server is coupled to said network, said remote device communicating with said gateway server via said network, said gateway server creating a proxy for each of said plurality of devices in said local network, and wherein a service of at least one of said plurality of devices can be invoked by said remote device utilizing said created proxy for said at least one of said plurality of devices.

12. The system according to claim 11, wherein said network is the Internet.

13. A wireless mailing system comprising:
a data center coupled to a network;
a gateway server coupled to said network, said gateway server communicating with said data center via said network; and
a plurality of devices associated with mail preparation, each of said plurality of devices adapted to communicate wirelessly with said gateway server,
wherein said data center receives information from and sends information to at least one of said plurality of devices via said network, said gateway server and a wireless communication between said gateway server and said at least one of said plurality of devices.

14. The system according to claim 13, wherein at least one of said plurality of devices transfers data to another of said plurality of devices via a wireless communication.

15. The system according to claim 14, wherein said wireless communication is routed through said gateway server.

16. The system according to claim 13, wherein said gateway server and said plurality of devices form a local network, said system further comprising:
a remote device coupled to said network, said remote device communicating with said gateway server via said network, said gateway server creating a proxy for each of said plurality of devices in said local network,
wherein a service of at least one of said plurality of devices can be invoked by said remote device utilizing said created proxy for said at least one of said plurality of devices.

17. The system according to claim 13, wherein said network is the Internet.

18. The system according to claim 13, wherein said network is a telephone network.

19. The system according to claim 13, wherein said plurality of devices includes a postage meter.

20. The system according to claim 13, wherein said plurality of devices includes a scale.

21. The system according to claim 13, wherein said plurality of devices includes a mail processing machine.

22. The system according to claim 13, wherein said plurality of devices includes a personal computer.

23. A method for sending data from a data center to a device associated with mail preparation comprising the steps of:
sending said data from said data center to a gateway server via a network;
establishing a wireless communication between said gateway server and said device; and
sending said data from said gateway server to said device via said wireless communication.

24. The method according to claim 23, wherein said step of establishing a wireless communication further comprises:
establishing a radio frequency communication.

25. The method according to claim 23, wherein said network is a telephone network.

26. The method according to claim 23, wherein said network is the Internet.

27. The method according to claim 23, wherein said device is a postage meter.

28. The method according to claim 27, wherein said data includes refill postage funds.

29. The method according to claim 23, wherein said device is a scale.

30. The method according to claim 29, wherein said data includes postage rates.

31. A method for invoking a service of a mailing device by a remote device, said mailing device belonging to a wireless mailing system, said method comprising the steps of:
registering said mailing device with a gateway server, said registration being done via a wireless communication between said mailing device and said gateway server;
creating a proxy for said registered mailing device and storing said proxy in said gateway server;
establishing a communication between said remote device and said gateway server via a network;
selecting a service associated with registered mailing device via said communication between said remote device and said gateway server; and
invoking said selected service via said proxy by said remote device.

32. The method according to claim 31, wherein said wireless communication between said mailing device and said gateway server is a radio frequency communication.

33. The method according to claim 31, wherein said step of selecting a service further comprises:
displaying a plurality of services associated with said registered device; and
selecting one of said plurality of services associated with said registered device.

34. The method according to claim 31, wherein said network is the Internet.

35. The method according to claim 31, wherein said mailing device is a postage meter.

36. The method according to claim 31, wherein said mailing device is a scale.

37. The method according to claim 31, wherein said service includes a status report.
